(19) United States
(12) Patent Application Publication
(10) Pub. No.: US 2018/0246589 A1
(43) Pub. Date: Aug. 30, 2018

(54) Layer Arrangement and Input/Output Device

(71) Applicant: Robert Bosch GmbH, Stuttgart (DE)

(72) Inventors: Yong Heng So, Singapore (SG); Suresh Palale, Singapore (SG); Pardhasaradhi Vemulamada, Singapore (SG)

(21) Appl. No.: 15/753,815

(22) PCT Filed: Aug. 20, 2015
(86) PCT No.: PCT/SG2015/050270

§ 371 Date: Feb. 20, 2018

(51) Int. Cl. G06F 3/041; H01B 1/12; G06F 3/01

(52) U.S. Cl. CPC G06F 3/041; G06F 3/016; H01B 1/122

(57) ABSTRACT

Various embodiments provide a layer arrangement. The layer arrangement includes a first transparent electrode layer, a second transparent electrode layer, and an ionic polymer electrolyte layer between the first transparent electrode layer and the second transparent electrode layer. The first layer detects at least one of a touch position and a force/pressure applied. The further layers are haptic actuators configured to output an haptic feedback in the form of a deformation of the further layers.

### TECHNICAL FIELD

The present invention relates to a layer arrangement and an input/output device.

### BACKGROUND

Haptics is a tactile feedback technology which recreate the sense of touch in a user interface design by applying force, vibrations, or motions to provide information to an end user. Haptic actuator technologies have great market potential especially in the consumer electronics where touch screen based devices, e.g. smart phones, and virtual interfaces are the main drivers.

Various existing haptic actuator technologies have been used to provide vibrational based haptic feedback to touch screens. Some known haptic actuators, such as linear resonant actuator (LRA) and eccentric rotating mass (ERM), are generally bulky, not scalable and lack of realistic feedback in haptics applications. Some other haptics actuator technologies are based on smart materials, such as piezo materials, shape memory alloys (SMAs), electroactive polymers (EAPs). A subgroup of EAP, dielectric elastomer EAP, capable of generating huge force and sufficient strain at high frequency can be of big use for haptic feedback technology. However, dielectric EAP based actuator normally requires high driving voltage of several thousands of volts, which lead to safety concerns in electrical insulation and protection. Further, the limitations of dielectric EAP in providing localized, high realistic and surface coverage haptics impede its application in haptics actuators.

Another sub-group of EAP, ionic polymer-metal composites (IPMC), has been identified as a promising candidate for soft actuators and sensors. IPMC is composed of an ionic polymer electrolyte plated with electrodes on both surfaces. Under an applied voltage, e.g. in the range of 1V-5V, ion migration and redistribution due to the imposed voltage across the IPMC result in a bending deformation of the IPMC, so as to perform as an actuator. Alternatively, if a deformation is physically applies to the IPMC, an output voltage signal, e.g. in the range of millivolts, will be generated, so as to perform as a sensor. Compared to other EAP materials, IPMC actuator exhibits a large bending displacement under very low applied voltage, and such mechanical deformation has been proposed for haptics applications. IPMC actuators usually have compliant top and bottom electrodes formed from noble metals, such as Pt, Ag, Au or carbon composites.

The current research and development for the IPMC material focuses mainly on optimizing its performance for use as sensors and actuators. Opaque metal electrodes, such as gold, platinum or silver, are commonly employed for IPMC in order to achieve better performance in the target applications of sensors, soft actuators, or biomedical actuators (e.g. micro-pump), etc.

### SUMMARY

According to the present invention, a layer arrangement as claimed in claim 1 is provided. An input/output device according to the invention is defined in claim 8. The dependent claims define some examples of such a layer arrangement and input/output device, respectively.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a schematic diagram of a layer arrangement according to various embodiments.

FIG. 2 shows an exemplary embodiment of the operation of a layer arrangement according to FIG. 1, for example.

FIG. 3 shows a schematic diagram of an input/output device according to an exemplary embodiment, which may include a layer arrangement according to FIG. 1, for example.

FIG. 4 shows a schematic diagram of an input/output device according to an exemplary embodiment, which may include a layer arrangement according to FIG. 1, for example.

FIG. 5 illustrates an exemplary embodiment of an operation of the input/output device.

FIG. 6 illustrates an exemplary embodiment of an operation of the input/output device.

FIG. 7 shows a schematic diagram of an input/output device according to an exemplary embodiment.

FIG. 8 shows a schematic diagram of an input/output device according to an exemplary embodiment.

### DESCRIPTION

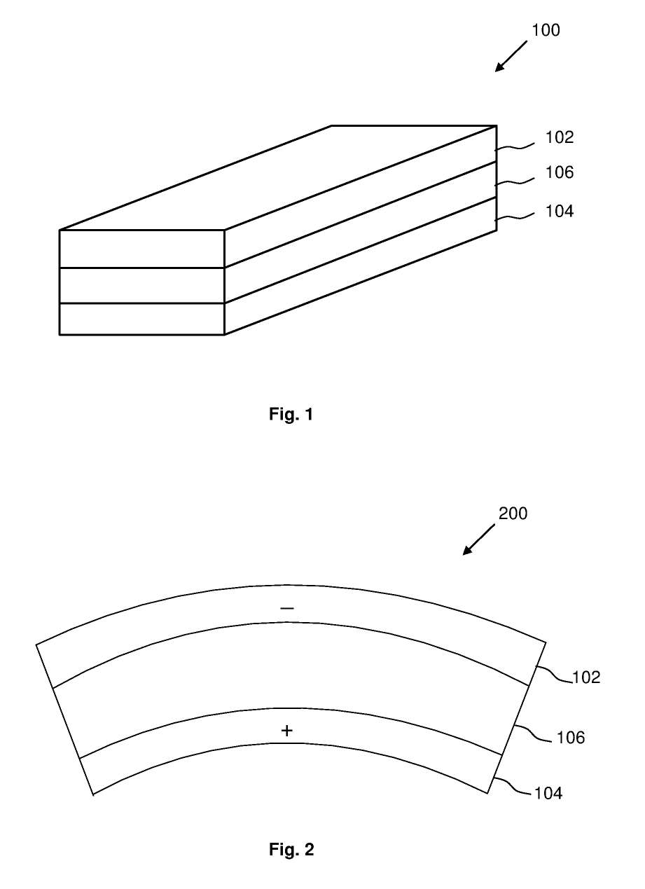

FIG. 1 shows a schematic diagram of a layer arrangement according to various embodiments. As shown in FIG. 1, a layer arrangement 100 includes a first transparent electrode layer 102, a second transparent electrode layer 104, and an ionic polymer electrolyte layer 106 between the first transparent electrode layer 102 and the second transparent electrode layer 104. The layer arrangement 100 is also referred to as Ionic Polymer Transparent Electrode Composite (IPTEC) structure in this description, which uses transparent electrode material to replace noble metal electrode used in ionic polymer-metal composites (IPMC). In various embodiments, the layer arrangement 100 is also referred to as transparent IPMC.

The first and the second transparent electrode layers 102, 104 each includes a material selected from silver nanowires (AgNWs), indium tin oxide (ITO), graphene, conducting polymers, or other suitable material having a desired transparency and electrical conductivity. The ionic polymer electrolyte layer 106 is substantially transparent. The ionic polymer electrolyte layer 106 may include or may refer to an ion exchange membrane integrated with electrolyte cations (e.g. Li⁺, Na⁺, or K⁺), electrolyte solvent (e.g. water, or ethylene glycol) or ionic liquid. Examples of the ion exchange membrane may include but are not limited to Nafion®, Flemion®, or Polyvinylidene fluoride (PVDF).

In an exemplary embodiment, the layer arrangement 100 is configured to output a haptic feedback upon an actuating signal applied between the first and the second transparent electrode layers 102, 104. The actuating signal may be a voltage or an electrical field applied between the layer 102 and the layer 104, for example. The layer arrangement 100 is or forms a haptic actuator 100 accordingly. The haptic actuator 100 may be configured to output the haptic feedback in the form of a deformation of at least a portion of the layer arrangement 100. The haptic actuator 100 may also be configured to output the haptic feedback in the form of a vibration of at least a portion of the layer arrangement 100.

FIG. 2 shows an exemplary embodiment 200 of the operation of the layer arrangement 100 according to FIG. 1, for example. As shown in FIG. 2, under an actuating signal applied between the first and the second transparent electrode layers 102, 104, e.g. a voltage applied between the first transparent electrode layer 102 and the second transparent electrode layer 104, the mechanical bending deformation of the ionic polymer electrolyte layer 106 and the transparent electrode layers 102, 104 is formed, which can be utilized for surface coverage haptic feedback. In other embodiments not shown in FIG. 2, a vibration of at least part of the ionic polymer electrolyte layer 106 and the transparent electrode layers 102, 104, may occur under the applied voltage.

The haptic feedback provided by the layer arrangement 100 may be dependent on the level (e.g. the magnitude) of the actuating signal. In other words, the level of a voltage or an electric field applied to the layer arrangement 100 may be adjusted/controlled (e.g. via power electronics) to achieve different haptic feedback strength (e.g. different deformation level of the layer arrangement). In an exemplary embodiment, the entire layer arrangement 100 is deformed and bent as shown in FIG. 2, under a voltage applied between the first transparent electrode layer 102 and the second transparent electrode layer 104. In other embodiments, only some of the layers 102, 104, 106 of the layer arrangement 100 is deformed or bent by adjusting the voltage applied between the layer 102 and the layer 104. In an exemplary embodiment, the location of haptic feedback may be determined based on the actuating signal.

In an exemplary embodiment, the layer arrangement 100 is configured to generate a sensing signal upon a deformation of at least a portion of the layer arrangement induced by a touch input, e.g. the touch input received on the surface of the layer arrangement 100, so as to detect the touch input. The layer arrangement 100 is or forms a touch sensor 100 accordingly.

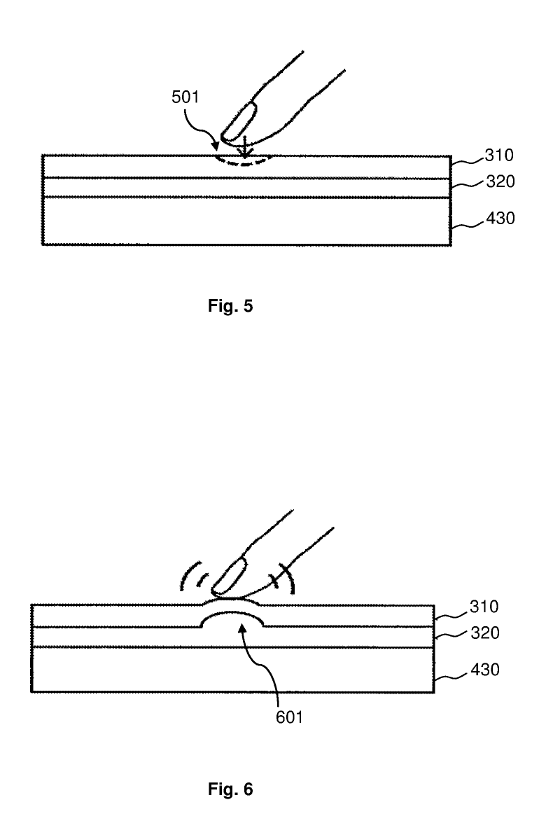

The touch input to the surface of the touch sensor 100 may induce a deformation of at least a portion of the layer arrangement 100 being touched, as will be illustrated in FIG. 5 below. The deformation may be induced locally at or around the location where the touch input is received (e.g. as shown in FIG. 5). The deformation may also be induced globally throughout the entire area of the layer arrangement 100. In various embodiments, depending on the strength of the touch input, one or more layers of the layer arrangement 100 may be deformed. For example, a larger force/pressure applied by the touch input may induce the deformation of all layers 102, 104, 106. Whereas a smaller force/pressure applied by the touch input may induce the deformation of some layers only, such as the deformation of the first transparent electrode layer 102 only, or the deformation of the first transparent electrode layer 102 and the ionic polymer electrolyte layer 106.

The one or more of the layers 102, 104, 106 of the touch sensor 100, when deformed, generates a sensing signal, e.g., a voltage signal, which can be sensed and measured to detect the touch. In an exemplary embodiment, when all layers 102, 104, 106 of the touch sensor 100 are deformed, a larger voltage signal is generated. When only some of the layers 102, 104, 106, such as the first transparent electrode layer 102 and the surface portion of the ionic polymer electrolyte layer 106 are deformed, a weaker voltage signal is generated. By measuring the strength of the voltage signal being generated, the touch sensor 100 may be configured to measure or determine the level/magnitude of the force/pressure applied by the touch input, and thus may be configured as a touch force/pressure sensor 100 accordingly.

In an exemplary embodiment, the touch sensor 100 is configured to detect at least one of a magnitude or a location of the touch input based on the sensing signal.

In accordance with various embodiments, transparent electrodes are integrated as the compliant electrodes of conventional IPMC to achieve a transparent solid-state touch sensor/haptic actuator. Various transparent electrode materials can be utilized to replace the non-transparent metal electrodes of IPMC. The ionic polymer with transparent electrodes, named as IPTEC, allows integration on top of a touch screen where the mechanical bending deformation under applied voltage (e.g. as shown in FIG. 2) can be utilized for surface coverage haptic feedback. On the other hand, transparent IPTEC can be configured as a touch sensor which is capable of detecting touch by detecting the voltage signal generated due to deformation induced by a touch input to the surface of the touch sensor. Further, the transparent IPTEC may also be configured as a force/pressure sensor which is capable of detecting the level/magnitude of touch force or pressure by measuring the voltage signal generated due to deformation of the IPTEC structure. Accordingly, the layer arrangement 100 described above may form a haptic actuator, or a touch sensor, or a force/pressure sensor, or a device functioning as a haptic actuator, a touch sensor and a force/pressure sensor simultaneously.

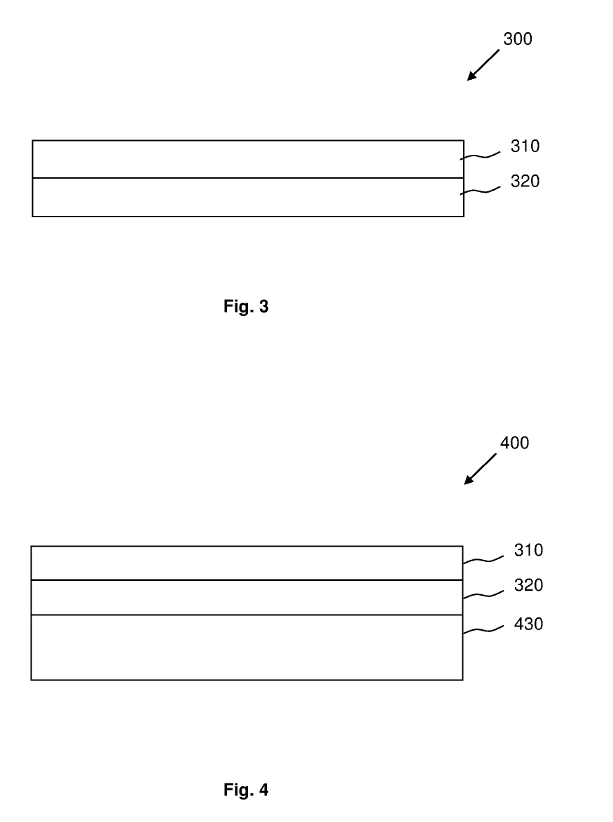

FIG. 3 shows a schematic diagram of an input/output device 300 according to an exemplary embodiment, which may include a layer arrangement according to FIG. 1, for example.

The input/output device 300 includes a first layer arrangement 310 and a second layer arrangement 320. Each of the first layer arrangement 310 and the second layer arrangement 320 is the same as the layer structure 100 of FIG. 1. Each of the first layer arrangement 310 and the second layer arrangement 320 includes a first transparent electrode layer, a second transparent electrode layer and an ionic polymer electrolyte layer between the first and the second transparent electrode layers. The materials of the first transparent electrode layer, the second transparent electrode layer and the ionic polymer electrolyte layer in the first layer arrangement 310 may be the same or may be different from the materials of the first transparent electrode layer, the second transparent electrode layer and the ionic polymer electrolyte layer in the second layer arrangement 320, respectively.

The first layer arrangement 310 is configured to generate a sensing signal upon a deformation of at least a portion of the first layer arrangement 310 induced by a touch input on a surface of the first layer arrangement 310. The first layer arrangement 310 may be referred to as a touch sensor layer to detect touch position and/or force/pressure applied by the touch. The second layer arrangement 320 is configured to output a haptic feedback upon the sensing signal applied between the first transparent electrode layer and the second transparent electrode layer of the second layer arrangement. In an exemplary embodiment, the sensing signal generated by the first layer arrangement 310 is a voltage signal, which is applied between the first transparent electrode layer and the second transparent electrode layer of the second layer arrangement, which thus induces the deformation of at least a portion of the second layer arrangement 320. The second layer arrangement 320 may be referred to as a haptic actuator layer.

The first layer arrangement 310 is configured to detect at least one of a magnitude or a location of the touch input based on the sensing signal. For example, the first layer arrangement 310 may be configured to measure the magnitude of the force applied through the touch by correlating to the touch-induced deformation level of the first layer arrangement 310. A larger touch-induced deformation level of the first layer arrangement 310 may generate a higher voltage sensing signal, and a smaller touch-induced deformation level of the first layer arrangement 310 may generate a lower voltage sensing signal.

The second layer arrangement 320 is configured to output the haptic feedback in the form of a deformation of at least a portion of the second layer arrangement 320, or a vibration of at least a portion of the second layer arrangement 320.

The deformation level or the vibration strength may be determined based on the magnitude of the sensing signal. The sensing signal, or a signal determined from the sensing signal, may be applied between the first transparent electrode layer and the second transparent electrode layer of the second layer arrangement 320. In an exemplary embodiment, the level of a voltage or an electric field applied to the second layer arrangement 320 may be adjusted/controlled (e.g. via power electronics) to achieve different haptic feedback strength based on the level of sensing signal. For example, a higher bending/deformation level of the second layer arrangement 320 is achieved, or the bending/deformation of the entire second layer arrangement 320 is achieved, when the higher voltage signal is applied thereto. In another example, a lower deformation level of the second layer arrangement 320 is achieved, or bending/deformation of only some of the internal layers 102, 104, 106 of the second layer arrangement 320 is achieved, when the lower voltage signal is applied thereto.

In an exemplary embodiment, the location/position of haptic feedback to be output may be determined based on the sensing signal. For example, the sensing signal is used to determine the location of touch input, which may be determined to be the location where the deformation of the second layer arrangement 320 is formed. In an embodiment, an electronic controller may be used to determine the location and/or level of haptic feedback output from the second layer arrangement 320.

In an exemplary embodiment as shown in FIG. 3, the first layer arrangement 310 is arranged on top of the second layer arrangement 320, and is configured to receive the touch input thereon. The bottom layer of the first layer arrangement 310, e.g., one of the transparent electrode layers of the first layer arrangement 310, is in contact with the top layer of the second layer arrangement 320, e.g. one of the transparent electrode layers of the second layer arrangement 320.

The haptic feedback output by the second layer arrangement 320 may be transferred to a user through the first arrangement 310, as will be described with reference to FIG. 6 below.

In an exemplary embodiment, the input/output device 300 may include a plurality of second layer arrangements to strengthen the haptic effect. In an exemplary embodiment, the input/output device 300 may include one or more further second layer arrangements (not shown), wherein each of the further second layer arrangement may have a similar structure as the second layer arrangement 320, including a first transparent electrode layer, a second transparent electrode layer, and an ionic polymer electrolyte layer between the first and the second transparent electrode layers. The second layer arrangement 320 and the further second layer arrangements may be stacked layer by layer under the first layer arrangement 310.

FIG. 4 shows a schematic diagram of an input/output device 400 according to an exemplary embodiment, which is similar to the input/output device 300 including the first layer arrangement 310 and the second layer arrangement 320. The input/output device 400 further includes a display layer 430, wherein the first layer arrangement 310 and the second layer arrangement 320 are arranged on top of the display layer 430, with the second layer arrangement 320 arranged in between the first layer arrangement 310 and the display layer 430.

Various embodiments described with regard to the layer arrangement in FIG. 1 and FIG. 2 above are analogously valid for the input/output device 300, 400, and vice versa.

As illustrated in FIG. 4, the layer arrangements 310, 320 with the IPTEC structure overlay or are integrated on top of the display layer 430. The top layer arrangement 310 deforms at the micro scale when touched, thereby acting as the touch sensor layer 310 to detect touch position and/or touch force/pressure applied to the layer arrangement 310, which is configured to generate a sensing signal when the layer arrangement is deformed. The bottom layer arrangement 320 acts as the haptic actuator layer 320 configured to provide a haptic effect upon receipt of the actuating signal that is based on the sensing signal. Hence, the IPTEC structures 310, 320 allow to function as a touch sensor and provide local haptic feedback at the same time.

The layer arrangements 310, 320 may have different electromechanical characteristics with each other, for example, by providing or controlling the thickness of the layer arrangements 310, 320, or by configuring the materials of the layer arrangements 310, 320. In an exemplary embodiment, the thickness of the ionic polymer electrolyte layer of the second layer arrangement 320 is increased by providing a thicker ion exchange membrane, as compared to the thickness of the ionic polymer electrolyte layer of the first layer arrangement 310, in order to increase the actuation force of the second layer arrangement 320 for better haptic feedback. In an exemplary embodiments, type of electrolyte cations, solvents and/or ionic liquid employed for the ionic polymer electrolyte layer may be different for the second layer arrangement 320 compared with the first layer arrangement 310, so as to achieve different electromechanical characteristics of the layer arrangements 310, 320.

FIG. 5 illustrates an exemplary embodiment of an operation of the input/output device, for example, the input/output device 300, 400 according to FIG. 3 and FIG. 4 above. As shown in FIG. 5, when a user touches the top surface of the first layer arrangement 310, finger pressure/force applied on the IPTEC touch sensor layer 310 causes a local deformation of the first layer arrangement 310, and is sensed via detecting the electrical signal generated by the touch-induced deformation of the IPTEC touch sensor layer 310. For example, only the portion of the touch sensor layer 310 at the location of the finger touch 501 may be deformed, and the correspondingly generated sensing signal may indicate the location of the touch. In an exemplary embodiment, the touch sensor layer 310 may be used not only to detect touch, but also to act as the touch force/pressure sensor layer to measure the magnitude of the applied force by correlating to the touch-induced deformation level of the first layer arrangement 310. By way of example, a higher deformation level may correlate to a larger magnitude of the applied force.

The sensing signal generated by the detected touch may then be used to actuate the second layer arrangement 320 acting as the haptic actuator layer, as depicted in FIG. 6. Under the sensing signal, the second layer arrangement 320 is deformed as shown in FIG. 6. In an exemplary embodiment, only the portion 601 of the second layer arrangement 320 at the location of the detected touch may be deformed, e.g. as a curved bending or protrusion along a direction substantially perpendicular to the main surface of the second layer arrangement 320. In an exemplary embodiment, the portion 601 of the second layer arrangement 320 at the location of the detected touch may be vibrated. The top layer of the second layer arrangement 320, e.g. the first transparent electrode layer contacting with the first layer arrangement 310, may be thin and flexible, so that the haptic feedback output from the second layer arrangement 320 is transferred to a user through the first layer arrangement 310. This makes it possible for the generated haptic effect to be transferred to the human finger interacting with the input/output device 300, 400, such that the user may feel the shape deformation or the vibration at the position of the finger. In an exemplary embodiment, multiple second layer arrangements 320 may be provided between the first layer arrangement 310 and the display layer 430, so that the haptic actuator layers formed by the multiple second layer arrangements are employed to strengthen the haptic effect, as compared to the haptic effect generated by a single second layer arrangement.

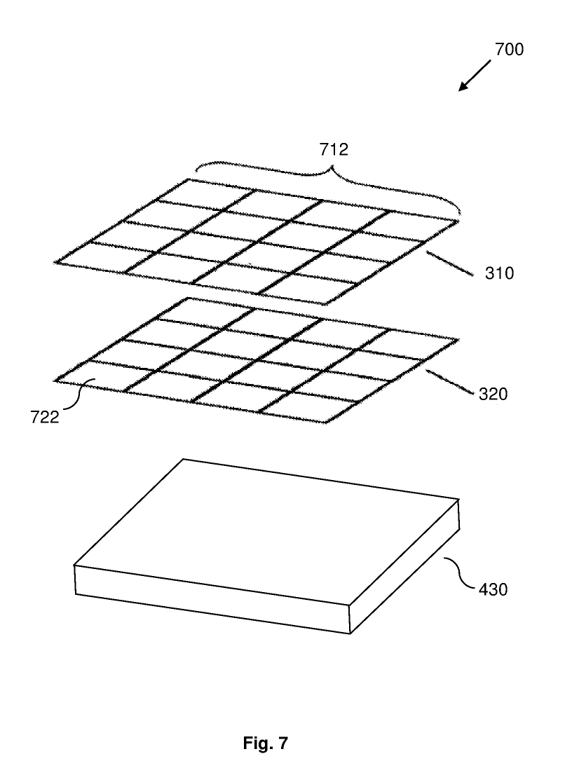

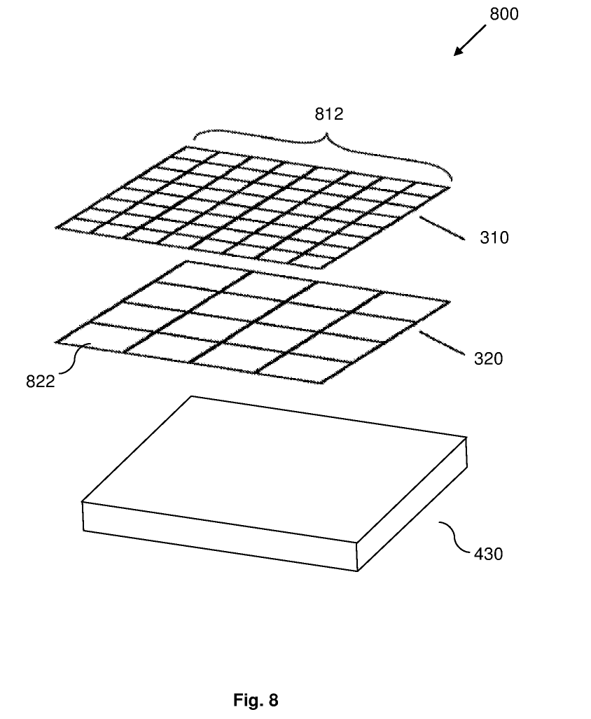

FIG. 7 and FIG. 8 shows a schematic diagram of an input/output device 700, 800 according to an exemplary embodiment.

The input/output device 700, 800 is similar to the input/output device 300, 400, and includes a first layer arrangement 310, a second layer arrangement 320, and a display layer 430, with the second layer arrangement arranged between the first layer arrangement 310 and the display layer 430. Various embodiments described with regard to the layer arrangement 100 and the input/output device 300, 400 in FIGS. 1-6 above are analogously valid for the input/output device 700, 800, and vice versa.

The substantial transparency of the IPTEC sensor and actuator layers 310, 320 allow the display 430 to be viewable through the layers 310, 320.

In an exemplary embodiment, the first layer arrangement 310 may include a first number of first cells of a first size, and the second layer arrangement 320 may include a second number of second cells of a second size. Each of the first cells and the second cells may have the IPTEC structure 100 of FIG. 1, and may be referred to as IPTEC first cells and IPTEC second cells, respectively.

In an exemplary embodiment shown in FIG. 7, the touch sensor layer 310 includes a 4×4 array of IPTEC first cells 712 which may be aligned with each other and arranged in the matrix form. The haptic actuator layer 320 similarly includes a 4×4 array of IPTEC second cells 722 which may be aligned with each other and arranged in the matrix form. The IPTEC first cells 712 arranged in the matrix form within the touch sensor layer 310 allows the location of an interaction (touch) to be determined. In response to a sensed touch, only the second cell 722 which is positioned in the region of the haptic actuator layer 320 corresponding to the location of the sensed signal operates independently from other second cells, so that the desired haptic effect at the desired location may be generated. In an exemplary embodiment, a multiplexer, may be used to command individual IPTEC cells 712, 722 to measure the sensing signal.

In an exemplary embodiment shown in FIG. 8, the touch sensor layer 310 includes a 8×8 array of IPTEC first cells 812 aligned with each other and arranged in the matrix form. The haptic actuator layer 320 includes a 4×4 array of IPTEC second cells 822 aligned with each other and arranged in the matrix form. The number of first cells 812 is larger than the number of second cells 822, and the size of each first cell 812 is smaller than the size of each second cell 822. The more and smaller first cells provided in the touch sensor layer 310 may be used to increase the sensing resolution of the touch sensor layer 310. The haptic actuator layer 320 includes fewer and larger second cells 822 to increase the haptic effect that can be provided by each second cell 822.

Although FIG. 7 and FIG. 8 shows exemplary embodiments of the cells arranged in matrix form, it is understood that the first cells of the first layer arrangement and the second cells of the second layer arrangement may also be arranged in other patterns and forms to achieve a desired sensing resolution and haptic effect.

In accordance with various embodiments, the transparent IPTEC structure is utilized as a transparent touch sensor, a transparent touch force/pressure sensor, a transparent haptic actuator, or a combined transparent touch sensor and actuator, to respectively measure a deformation of a surface and provide haptic feedback as a result of the deformation. The transparent IPTEC structure of the embodiments has great potential as surface coverage haptics technology for touch screen applications such as consumer electronics as well as virtual interfaces.

Various embodiments provide IPMC with transparent electrodes to form an IPTEC structure, and propose to employ the transparent IPTEC structure in a haptic actuator and/or a touch sensor which can be used as an input/output device and can be put on a display for touch screen applications. The IPTEC structure of various embodiments is further employed for an application of fully transparent touch sensor/haptic actuator layer stack which can be integrated on top of a display to provide an input/output device.

Compared with conventional opaque haptic actuators that are integrated beneath the display to provide vibrational feedback driven by a separate touch sensing unit (e.g. of a resistive or capacitive type), the transparent IPTEC structure of the embodiments can be used to form combined touch sensor and haptic actuator layers that overlay the top of a display. This allows the sensor and actuator functionality to be achieved by a single module, which leads to lowered cost, thinner and more compact solution with simpler integration methods.

As opposed to conventional touch screen technology, there is no need to provide an external voltage for the sensor functionality of the IPTEC structure to work. Instead, upon deformation applied on top of each IPTEC structure, the electrical signal generated may be used as a measure of the magnitude of the applied pressure with high resolution. Further, the low driving voltage of the IPTEC structure is advantageous as the haptics actuator, which eliminates the need of electrical insulation or complex and costly electronic circuits being required by high voltage driven actuators.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A layer arrangement, comprising
a first transparent electrode layer;
a second transparent electrode layer; and
an ionic polymer electrolyte layer between the first transparent electrode layer and the second transparent electrode layer.

2. The layer arrangement of claim 1, wherein the first transparent electrode layer and the second transparent electrode layer each respectively includes a material selected from a group consisting of silver nanowires, indium tin oxide, graphene, and conducting polymers.

3. The layer arrangement of claim 1, wherein the ionic polymer electrolyte layer includes an ion exchange membrane integrated with at least one of electrolyte cations, electrolyte solvent, and ionic liquid.

4. The layer arrangement of claim 1, wherein the layer arrangement is configured to output a haptic feedback in response to an actuating signal applied between the first transparent electrode layer and the second transparent electrode layer.

5. The layer arrangement of claim 4, wherein the layer arrangement is further configured to output the haptic feedback in the form of a deformation of at least a portion of the layer arrangement or in the form of a vibration of at least a portion of the layer arrangement.

6. The layer arrangement of claim 1, wherein the layer arrangement is configured to generate a sensing signal in response to a deformation of at least a portion of the layer arrangement induced by a touch input, so as to detect the touch input.

7. The layer arrangement of claim 6, wherein:
the sensing signal is a voltage signal; and
the layer arrangement is further configured to detect at least one of a magnitude and a location of the touch input based on the voltage signal.

8. An input/output device, comprising
a first layer arrangement; and
a second layer arrangement;
wherein the first layer arrangement and the second layer arrangement each respectively includes a first transparent electrode layer, a second transparent electrode layer, and an ionic polymer electrolyte layer between the first transparent electrode layer and the second transparent electrode layer.

9. The input/output device of claim 8, wherein the first and the second transparent electrode layers of the first and the second layer arrangements each respectively includes a material selected from a group consisting of silver nanowires, indium tin oxide, graphene, and conducting polymers.

10. The input/output device of claim 8, wherein the ionic polymer electrolyte layer of the first and the second layer arrangements each respectively includes an ion exchange membrane integrated with at least one of electrolyte cations, electrolyte solvent, and ionic liquid.

11. The input/output device of claim 8, wherein:
the first layer arrangement is configured to generate a sensing signal in response to a deformation of at least a portion of the first layer arrangement induced by a touch input; and
the second layer arrangement is configured to output a haptic feedback in response to the sensing signal applied between the first transparent electrode layer and the second transparent electrode layer of the second layer arrangement.

12. The input/output device of claim 11, wherein;
the sensing signal is a voltage signal and
the first layer arrangement is configured to detect at least one of a magnitude and a location of the touch input based on the voltage signal.

13. The input/output device of claim 11, wherein the second layer arrangement is configured to output the haptic feedback in the form of a deformation of at least a portion of the second layer arrangement or in the form of a vibration of at least a portion of the second layer arrangement.

14. The input/output device of claim 11, wherein the haptic feedback output by the second layer arrangement is transferred to a user through the first layer arrangement.

15. The input/output device of claim 8, wherein:
the first layer arrangement further includes a first number of first cells of a first size; and
the second layer arrangement further includes a second number of second cells of a second size.

16. The input/output device of claim 15, wherein:
the first number is equal to the second number, and the first size is equal to the second size; or
the first number is larger than the second number, and the first size is smaller than the second size.

17. The input/output device of claim 15, wherein the first layer arrangement is configured to detect a location of a touch input based on a sensing signal generated by a one of the first cells at the location of the touch input.

18. The input/output device of claim 17, wherein the second layer arrangement is configured to output the haptic feedback to a one of the second cells located corresponding to the location of the touch input.

19. The input/output device of claim 8, further comprising:
a display layer, wherein the second layer arrangement is arranged in between the first layer arrangement and the display layer.

20. The input/output device of claim 8, further comprising:
one or more further second layer arrangements;
wherein each further second layer arrangement respectively includes a first transparent electrode layer, a second transparent electrode layer, and an ionic polymer electrolyte layer between the first transparent electrode layer and the second transparent electrode layer.
